(19) United States
(12) Patent Application Publication
(10) Pub. No.: US 2003/0139481 A1
(43) Pub. Date: Jul. 24, 2003

(54) Trialkylsiloxy silicate emulsion production process

(75) Inventor: Yoshihito Osawa, Takasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 10/335,877

(22) Filed: Jan. 3, 2003

(30) Foreign Application Priority Data
Jan. 23, 2002 (JP) 2002-014623

(51) Int. Cl. C09K 3/00

(52) U.S. Cl. 516/53

(57) ABSTRACT

A production process for a trialkylsiloxy silicate emulsion is provided. In this process, (A) an organodisiloxane, and (B) a tetraalkoxysilane and/or a partial hydrolysis-condensation product thereof are added to an aqueous solution including a surfactant, so that the molar ratio of R₃SiO_{0.5} units within the constituent (A) relative to SiO_{4/2} units within the constituent (B) is within a range from 0.5 to 2.0, and subsequent polymerization is then conducted at 30 to 90° C.

### BACKGROUND OF THE INVENTION

1. Field of the Invention

The present invention relates to a production process for a trialkylsiloxy silicate emulsion.

2. Description of the Prior Art

Trialkylsiloxy silicates are added to many resins for a variety of purposes such as improving the durability, improving the adhesion and imparting water repellency, and are widely used in a variety of industrial fields. The trialkylsiloxy silicate is typically dissolved in an organic solvent prior to use, although in recent years, with the move towards the elimination of solvents from many industrial processes in order to prevent environmental pollution problems, the demand has grown for a water based trialkylsiloxy silicate. Trialkylsiloxy silicates are solids, and consequently when converted to an emulsion, are typically first dissolved in an organic solvent or a volatile organopolysiloxane, with this solution then undergoing emulsification. However, this process results in the environmental pollution causing organic solvent remaining within the emulsion.

An example of a known process for producing an emulsion without the use of organic solvents is a process in which a triorganoalkoxysilane or a triorganosilanol, and a tetraalkoxysilane or a partial hydrolysis-condensation product thereof are added to an aqueous solution of an emulsifier at pH 1 to 7, and these alkoxysilanes are then polymerized (Japanese Laid-open publication (kokai) No. 8-199066 (JP8-199066A)). However, the production processes for trialkylalkoxysilanes and trialkylsilanols are complex, and use of these materials as everyday industrial raw materials is not economically viable. Furthermore, a production process for an organopolysiloxane hydrosol in which an alkoxysilane is polymerized in an aqueous solution of an emulsifier at a temperature below 15° C. is also known (Japanese Post-Examination publication (kokoku) No. 7-39494 (JP7-39494B)), although this process does not enable the production of a uniform emulsion of a trialkylsiloxy silicate.

### SUMMARY OF THE INVENTION

An object of the present invention is to provide a process for producing a trialkylsiloxy silicate emulsion which is simple, uses no organic solvents, and is economical as a result of using general purpose raw materials.

The present invention provides a production process for a trialkylsiloxy silicate emulsion, which comprises:

adding

(A) an organodisiloxane represented by a general formula (I):

R₃Si—O—SiR₃ (I)

wherein, each R represents, independently, an alkyl group of 1 to 10 carbon atoms, and

(B) at least one compound selected from the group consisting of tetraalkoxysilanes represented by a general formula (II):

Si(OR)₄ (II)

wherein, each R represents, independently, an alkyl group of 1 to 10 carbon atoms, and partial hydrolysis-condensation products thereof,

to an aqueous solution comprising:

(C) a surfactant, and

(D) water,

said constituents (A) and (B) being present such that a molar ratio of trialkylsiloxy units R₃SiO_{0.5} within said constituent (A) relative to tetrafunctional units SiO_{4/2} within said constituent (B) is within a range from 0.5 to 2.0; and

subsequently polymerizing the constituents (A) and (B) at 30 to 90° C.

### DETAILED DESCRIPTION OF THE PREFERRED EMBODIMENTS

As follows is a more detailed description of the present invention.

<Reaction Raw Materials>

An organodisiloxane of the constituent (A), represented by a general formula (I):

R₃Si—O—SiR₃ (I)

(wherein, R is as defined above) is used for blocking terminals with trialkylsiloxy groups. Specific example of the groups R within the general formula (I) include methyl groups, ethyl groups, n-propyl groups, iso-propyl groups, n-butyl groups, iso-butyl groups, t-butyl groups, as well as straight chain or branched pentyl groups, hexyl groups, heptyl groups, octyl groups, nonyl groups or decyl groups, although methyl groups are preferred.

A tetraalkoxysilane of the constituent (B), represented by a general formula (II):

Si(OR)₄ (II)

(wherein, R is as defined above) or a partial hydrolysis-condensation product thereof functions as a source of SiO_{4/2} unit structures. The groups R of the general formula (II) may be the same as those described above for the general formula (I), although from the viewpoint of ensuring good polymerization reactivity, methyl groups, ethyl groups, n-propyl groups and iso-propyl groups are preferred, and methyl groups and ethyl groups are particularly desirable.

Furthermore, partial hydrolysis-condensation products are preferred to the associated tetraalkoxysilanes as they enable a reduction in the production of alcohol by-products.

The constituent (A) and the constituent (B) are combined so that the molar ratio of trialkylsiloxy units R₃SiO_{0.5} within the constituent (A) relative to tetrafunctional units SiO_{4/2} within the constituent (B) is within a range from 0.5 to 2.0, and preferably from 0.7 to 1.5. If the molar ratio is too low then the mixture may gel, whereas if the ratio is too high, phase separation may occur, and in either case, a uniform emulsion cannot be obtained.

The surfactant of the constituent (C) aids the uniform dispersion of the constituents (A) and (B) within the aqueous medium. There are no particular restrictions on the surfactant, and suitable examples include anionic surfactants such as alkyl sulfates, alkylbenzenesulfonic acids and alkyl phosphates; nonionic surfactants such as polyoxyethylene alkyl ethers, polyoxyethylene alkylphenyl ethers and polyoxyethylene fatty acid esters; cationic surfactants such as quaternary ammonium salts and alkylamine acetates; and amphoteric surfactants such as alkylbetaines and alkylimidazolines, and these surfactants may be used singularly, or in combinations of two or more different surfactants. Of the above surfactants, anionic surfactants are preferred from the viewpoints of polymerization reactivity and stability. The quantity of the constituent (C) is typically within a range from 0.1 to 20 parts by weight, and preferably 0.3 to 10 parts by weight, per 100 parts by weight of the combined quantity of the constituent (A) and the constituent (B).

The quantity of water of the constituent (D) is typically within a range from 50 to 2000 parts by weight, and preferably from 100 to 1000 parts by weight, per 100 parts by weight of the combined quantity of the constituent (A) and the constituent (B).

An effective quantity of a polymerization catalyst for the constituent (A) and the constituent (B), such as an acidic material such as sulfuric acid, hydrochloric acid, phosphoric acid, acetic acid, formic acid, lactic acid or trifluoroacetic acid, or an alkali material such as potassium hydroxide, sodium hydroxide or ammonia may also be added. However, in those cases in which an acidic material such as an alkyl sulfate, an alkylbenzenesulfonic acid or an alkyl phosphate is used as the surfactant of the constituent (C), a separate polymerization catalyst need not be added.

<Reaction Conditions>

The aqueous solution of the constituent (C) and the constituent (D) (and where necessary a polymerization catalyst) is heated to a temperature of 30 to 90° C., and the constituent (A) and the constituent (B) are then added dropwise with constant stirring. The resulting mixture is then maintained at a temperature of 30 to 90° C. for a further 1 to 100 hours to allow the polymerization to proceed, and the mixture is then neutralized, using either an alkali material such as sodium carbonate, ammonia, sodium hydroxide or triethanolamine in those cases in which an acidic catalyst or an acidic constituent (C) were used, or an acidic material such as acetic acid, formic acid, phosphoric acid or hydrochloric acid in those cases in which an alkali catalyst was used. If the temperature is less than 30° C., then the reaction of the organodisiloxane of the constituent (A) fails to proceed adequately, and a uniform emulsion cannot be obtained, whereas if the temperature exceeds 90° C., the stability of the emulsion deteriorates. Temperatures within a range from 40 to 85° C. are even more preferred.

A process in which the constituent (B) is first polymerized within the aqueous solution of the constituent (C) and the constituent (D) (and where necessary a polymerization catalyst) at a temperature of 30 to 90° C., and the constituent (A) is then added dropwise and further polymerization is performed at a temperature of 30 to 90° C., is also possible.

Furthermore, in the production, dialkoxydialkylsilanes, trialkoxyalkylsilanes, and partial hydrolysis-condensation products thereof may also be added without any problems.

### EXAMPLES

As follows is a more specific description of the present invention using a series of examples. In the following description, the term “M unit” refers to a (CH₃)₃SiO_{0.5} unit, and the term “Q unit” refers to a SiO_{4/2} unit.

### Example 1

4 g of dodecylbenzenesulfonic acid and 738 g of water were placed in a 2 liter glass stirring apparatus equipped with a thermometer, and heated to a temperature of 50° C. A mixture of 100 g of hexamethyldisiloxane and 145 g of a partial hydrolysis-condensation product of tetramethoxysilane (methyl silicate 51 manufactured by Colcoat Co., Ltd., 51% by weight of SiO_{4/2}) (M units/Q units molar ratio at addition=1.0) was then added dropwise to the aqueous solution over a two hour period, and the polymerization was then allowed to proceed for a further 6 hours at 50° C. The reaction mixture was then neutralized with 13 g of a 3% aqueous solution of ammonia, and yielded a pale colored, semi-transparent emulsion. The emulsion had a pH of 8.8, and a non-volatile component of 17.2% by weight. Analysis of this non-volatile component by NMR, revealed a M units/Q units molar ratio of approximately 0.95, and the average molecular weight as measured by GPC was approximately 3000.

### Example 2

10 g of dodecylbenzenesulfonic acid and 745 g of water were placed in the apparatus described in the example 1, and heated to a temperature of 50° C. 145 g of a partial hydrolysis-condensation product of tetramethoxysilane (methyl silicate 51 manufactured by Colcoat Co., Ltd., 51% by weight of SiO_{4/2}) was then added, and the polymerization was allowed to proceed for 2 hours at 50° C. 100 g of hexamethyldisiloxane was then added to the reaction mixture dropwise over a one hour period, and the polymerization was allowed to proceed for a further 3 hours at 50° C. The reaction mixture was then neutralized with 24 g of a 10% aqueous solution of sodium carbonate, and yielded an almost colorless, transparent emulsion. The emulsion had a pH of 6.4, and a non-volatile component of 17.2% by weight. Analysis of this non-volatile component by NMR, revealed a M units/Q units molar ratio of approximately 0.95, and the average molecular weight as measured by GPC was approximately 4000.

### Example 3

10 g of dodecylbenzenesulfonic acid and 705 g of water were placed in the apparatus described in the example 1, and heated to a temperature of 50° C. A mixture of 100 g of hexamethyldisiloxane and 185 g of tetramethoxysilane (M units/Q units molar ratio at addition=1.0) was then added dropwise to the aqueous solution over a two hour period, and the polymerization was then allowed to proceed for a further 6 hours at 50° C. The reaction mixture was then neutralized with 24 g of a 10% aqueous solution of sodium carbonate, and yielded a pale colored, semi-transparent emulsion. The emulsion had a pH of 6.4, and a non-volatile component of 17.9% by weight. Analysis of this non-volatile component by NMR, revealed a M units/Q units molar ratio of approximately 0.95, and the average molecular weight as measured by GPC was approximately 3000.

### Example 4

4 g of dodecylbenzenesulfonic acid and 758 g of water were placed in the apparatus described in the example 1, and heated to a temperature of 50° C. A mixture of 80 g of hexamethyldisiloxane and 145 g of a partial hydrolysis-condensation product of tetramethoxysilane (methyl silicate 51 manufactured by Colcoat Co., Ltd., 51% by weight of SiO_{4/2}) (M units/Q units molar ratio at addition=0.8) was then added dropwise to the aqueous solution over a two hour period, and the polymerization was then allowed to proceed for a further 6 hours at 50° C. The reaction mixture was then neutralized with 13 g of a 3% aqueous solution of ammonia, and yielded an almost colorless, transparent emulsion. The emulsion had a pH of 8.5, and a non-volatile component of 15.0% by weight. Analysis of this non-volatile component by NMR, revealed a M units/Q units molar ratio of approximately 0.76, and the average molecular weight as measured by GPC was approximately 3500.

### Example 5

4 g of dodecylbenzenesulfonic acid and 786 g of water were placed in the apparatus described in the example 1, and heated to a temperature of 50° C. A mixture of 150 g of hexamethyldisiloxane and 145 g of a partial hydrolysis-condensation product of tetramethoxysilane (methyl silicate 51 manufactured by Colcoat Co., Ltd., 51% by weight of SiO_{4/2}) (M units/Q units molar ratio at addition=1.5) was then added dropwise to the aqueous solution over a two hour period, and the polymerization was then allowed to proceed for a further 6 hours at 50° C. The reaction mixture was then neutralized with 13 g of a 3% aqueous solution of ammonia, and yielded a pale colored emulsion. The emulsion had a pH of 8.9, and a non-volatile component of 21.8% by weight. Analysis of this non-volatile component by NMR, revealed a M units/Q units molar ratio of approximately 1.4, and the average molecular weight as measured by GPC was approximately 2500.

### Comparative Example 1

With the exception of altering the temperature to 15° C., a polymerization was conducted in the same manner as the example 1, but when the stirring was halted, the reaction mixture separated into two phases, and a uniform emulsion could not be obtained.

### Comparative Example 2

4 g of dodecylbenzenesulfonic acid and 798 g of water were placed in the apparatus described in the example 1, and heated to a temperature of 50° C. A mixture of 40 g of hexamethyldisiloxane and 145 g of a partial hydrolysis-condensation product of tetramethoxysilane (methyl silicate 51 manufactured by Colcoat Co., Ltd., 51% by weight of SiO_{4/2}) (M units/Q units molar ratio at addition=0.4) was then added dropwise to the aqueous solution over a two hour period, and the polymerization was then allowed to proceed for a further 6 hours at 50° C. When the reaction mixture was subsequently neutralized with 13 g of a 3% aqueous solution of ammonia, the mixture gelled, and a uniform emulsion could not be obtained.

### Comparative Example 3

4 g of dodecylbenzenesulfonic acid and 628 g of water were placed in the apparatus described in the example 1, and heated to a temperature of 50° C. A mixture of 210 g of hexamethyldisiloxane and 145 g of a partial hydrolysis-condensation product of tetramethoxysilane (methyl silicate 51 manufactured by Colcoat Co., Ltd., 51% by weight of SiO_{4/2}) (M units/Q units molar ratio at addition=2.1) was then added dropwise to the aqueous solution over a two hour period, and the polymerization was then allowed to proceed for a further 6 hours at 50° C. However, when the stirring was halted, the reaction mixture separated into two phases, and a uniform emulsion could not be obtained.

According to a process of the present invention, a trialkylsiloxy silicate emulsion which contains no organic solvents can be produced by a simple process, using general purpose raw materials.

What is claimed is:

1. A production process for a trialkylsiloxy silicate emulsion, which comprises:
adding
(A) an organodisiloxane represented by a general formula (I):
R₃Si—O—SiR₃ (I)
wherein, each R represents, independently, an alkyl group of 1 to 10 carbon atoms, and
(B) at least one compound selected from the group consisting of tetraalkoxysilanes represented by a general formula (II):
Si(OR)₄ (II)
wherein, each R represents, independently, an alkyl group of 1 to 10 carbon atoms, and partial hydrolysis-condensation products thereof,
to an aqueous solution comprising:
(C) a surfactant, and
(D) water,
said constituents (A) and (B) being present such that a molar ratio of trialkylsiloxy units R₃SiO_{0.5} within said constituent (A) relative to tetrafunctional units SiO_{4/2} within said constituent (B) is within a range from 0.5 to 2.0; and
subsequently polymerizing the constituents (A) and (B) at 30 to 90° C.

2. The production process according to claim 1, wherein R within said general formula (I) represents a methyl group.

3. The production process according to claim 1, wherein R within said general formula (II) represents either a methyl group or an ethyl group.

4. The production process according to claim 1, wherein said constituent (B) is a partial hydrolysis-condensation product of said tetraalkoxysilane.

5. The production process according to claim 1, wherein said molar ratio R₃SiO_{0.5}/SiO_{4/2} is within a range from 0.7 to 1.5.

6. The production process according to claim 1, wherein a surfactant of said constituent (C) is an anionic surfactant.

7. The production process according to claim 1, wherein a quantity of a surfactant of said constituent (C) is within a range from 0.1 to 20 parts by weight per 100 parts by weight of a combined total of said constituent (A) and said constituent (B).

8. The production process according to claim 1, wherein a quantity of a surfactant of said constituent (C) is within a range from 0.3 to 10 parts by weight per 100 parts by weight of a combined total of said constituent (A) and said constituent (B).

9. The production process according to claim 1, wherein a quantity of water of said constituent (D) is within a range from 50 to 2000 parts by weight per 100 parts by weight of a combined total of said constituent (A) and said constituent (B).

10. The production process according to claim 1, wherein a quantity of water of said constituent (D) is within a range from 100 to 1000 parts by weight per 100 parts by weight of a combined total of said constituent (A) and said constituent (B).

11. The production process according to claim 1, wherein said constituent (A) and said constituent (B) are polymerized in the presence of an acidic material or an alkali material which functions as a polymerization catalyst.

12. The production process according to claim 1, wherein said constituent (B) is a partial hydrolysis-condensation product of a tetraalkoxysilane represented by said general formula (II), and said constituent (C) is an anionic surfactant.
